(19) United States
(12) Patent Application Publication
(10) Pub. No.: US 2006/0013310 A1
(43) Pub. Date: Jan. 19, 2006

(54) Temporal decomposition and inverse temporal decomposition methods for video encoding and decoding and video encoder and decoder

(75) Inventors: Jae-young Lee, Suwon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/182,004

(22) Filed: Jul. 15, 2005

Related U.S. Application Data
(60) Provisional application No. 60/588,039, filed on Jul. 15, 2004.

(30) Foreign Application Priority Data
Jul. 26, 2004 (KR) 10-2004-0058268
Nov. 23, 2004 (KR) 10-2004-0096458

(51) Int. Cl. H04N 11/02; H04N 11/04; H04N 7/12; H04B 1/66

(52) U.S. Cl. 375/240.16; 375/240.12; 375/240.03; 375/240.24; 375/240.21

(57) ABSTRACT

Temporal decomposition and inverse temporal decomposition methods using smoothed predicted frames for video encoding and decoding and video encoder and decoder are provided. The temporal decomposition method for video encoding includes estimating the motion of a current frame using at least one frame as a reference and generating a predicted frame, smoothing the predicted frame and generating a smoothed predicted frame, and generating a residual frame by comparing the smoothed predicted frame with the current frame.

### CROSS-REFERENCE TO RELATED APPLICATIONS

This application claims priorities from Korean Patent Application No. 10-2004-0058268 filed on Jul. 26, 2004 in the Korean Intellectual Property Office, Korean Patent Application No. 10-2004-0096458 filed on Nov. 23, 2004 in the Korean Intellectual Property Office, and U.S. Provisional Patent Application No. 60/588,039 filed on Jul. 15, 2004 in the United States Patent and Trademark Office, the disclosures of which are incorporated herein by reference in their entirety.

### BACKGROUND OF THE INVENTION

1. Field of the Invention

The present invention relates to video coding, and more particularly, to a method for improving image quality and efficiency for video coding using a smoothed predicted frame.

2. Description of the Related Art

With the development of information communication technology including the Internet, video communication as well as text and voice communication has explosively increased. Conventional text communication cannot satisfy users' various demands, and thus multimedia services that can provide various types of information such as text, pictures, and music have increased. Multimedia data requires a large capacity of storage media and a wide bandwidth for transmission since the amount of multimedia data is usually large in relative terms to other types of data. Accordingly, a compression coding method is required for transmitting multimedia data including text, video, and audio. For example, a 24-bit true color image having a resolution of 640*480 needs a capacity of 640*480*24 bits, i.e., data of about 7.37 Mbits, per frame. When an image such as this is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

In such a compression coding method, a basic principle of data compression lies in removing data redundancy. Data redundancy is typically defined as: (i) spatial redundancy in which the same color or object is repeated in an image; (ii) temporal redundancy in which there is little change between adjacent frames in a moving image or the same sound is repeated in audio; or (iii) mental visual redundancy taking into account that human eyesight and perception are not sensitive to high frequencies. Data can be compressed by removing such data redundancy. Data compression can largely be classified into lossy/lossless compression, according to whether source data is lost, intraframe/interframe compression, according to whether individual frames are compressed independently, and symmetric/asymmetric compression, according to whether time required for compression is the same as time required for recovery. In addition, data compression is defined as real-time compression when a compression/recovery time delay does not exceed 50 ms and as scalable compression when frames have different resolutions. As examples, for text or medical data, lossless compression is usually used. For multimedia data, lossy compression is usually used.

Meanwhile, currently used transmission media have various transmission rates. For example, an ultrahigh-speed communication network can transmit data of several tens of megabits per second while a mobile communication network has a transmission rate of 384 kilobits per second. In related art video coding methods such as Motion Picture Experts Group (MPEG)-1, MPEG-2, H.263, and H.264, temporal redundancy is removed by motion compensation based on motion estimation and compensation, and spatial redundancy is removed by transform coding. These methods have satisfactory compression rates, but they do not have the flexibility of a truly scalable bitstream since they use a reflexive approach in a main algorithm. Recently, a wavelet-based scalable video coding technique capable of providing truly scalable bitstreams has been actively researched. A scalable video coding technique means a video coding method having scalability. Scalability indicates the ability to partially decode a single compressed bitstream, that is, the ability to perform a variety of types of video reproduction. Scalability includes spatial scalability indicating a video resolution, Signal to Noise Ratio (SNR) scalability indicating a video quality level, temporal scalability indicating a frame rate, and a combination thereof.

Among many techniques used for wavelet-based scalable video coding, motion compensated temporal filtering (MCTF) that was introduced by Ohm and improved by Choi and Wood is an essential technique for removing temporal redundancy and for video coding having flexible temporal scalability. In MCTF, coding is performed on a group of pictures (GOPs) and a pair of a current frame and a reference frame are temporally filtered in a motion direction.

FIG. 1 shows the configuration of a conventional scalable video encoder. FIG. 2 illustrates a temporal filtering process using 5/3 Motion-Compensated Temporal Filtering (MCTF).

Referring to FIG. 1, the scalable video encoder includes a motion estimator 110 estimating motion between input video frames to determine motion vectors, a motion-compensated temporal filter 140 compensating the motion of an interframe using the motion vectors and removing temporal redundancies within the interframe subjected to motion compensation, a spatial transformer 150 removing spatial redundancies within an intraframe and the interframe within which the temporal redundancies have been removed and producing transform coefficients, a quantizer 160 quantizing the transform coefficients in order to reduce the amount of data, a motion vector encoder 120 encoding a motion vector in order to reduce the number of bits required for the motion vector, and a bitstream generator 130 generating a bitstream using the quantized transform coefficients and the encoded motion vectors.

The motion estimator 110 calculates a motion vector to be used in compensating the motion of a current frame and removing temporal redundancies within the current frame. The motion vector is defined as a displacement from the best-matching block in a reference frame with respect to a block in a current frame. In a Hierarchical Variable Size Block Matching (HVSBM) algorithm, one of various known motion estimation algorithms, a frame having an N*N resolution is first downsampled to form frames with lower resolutions such as N/2*N/2 and N/4*N/4 resolutions. Then, a motion vector is obtained at the N/4*N/4 resolution and a motion vector having N/2*N/2 resolution is obtained using the N/4*N/4 resolution motion vector. Similarly, a motion vector with N*N resolution is obtained using the N/2*N/2 resolution motion vector. After obtaining the motion vectors at each resolution, the final block size and the final motion vector are determined through a selection process.

The motion-compensated temporal filter 140 removes temporal redundancies within a current frame using the motion vectors obtained by the motion estimator 110. To accomplish this, the motion-compensated temporal filter 140 uses a reference frame and motion vectors to generate a predicted frame and compares the current frame with the predicted frame to thereby generate a residual frame. The temporal filtering process will be described in more detail later with reference to FIG. 2.

The spatial transformer 150 spatially transforms the residual frames to obtain transform coefficients. The video encoder removes spatial redundancies within the residual frames using wavelet transform. The wavelet transform is used to generate a spatially scalable bitstream.

The quantizer 160 uses an embedded quantization algorithm to quantize the transform coefficients obtained through the spatial transformer 150. The motion vector encoder 120 encodes the motion vectors calculated by the motion estimator 110.

The bitstream generator 130 generates a bitstream containing the quantized transform coefficients and the encoded motion vectors.

A MCTF algorithm will now be described with reference to FIG. 2. For convenience of explanation, a group of picture (GOP) size is assumed to be 16.

First, in temporal level 0, a scalable video encoder receives 16 frames and performs MCTF forward with respect to the 16 frames, thereby obtaining 8 low-pass frames and 8 high-pass frames. Then, in temporal level 1, MCTF is performed forward with respect to the 8 low-pass frames, thereby obtaining 4 low-pass frames and 4 high-pass frames. In temporal level 2, MCTF is performed forward with respect to the 4 low-pass frames obtained in temporal level 1, thereby obtaining 2 low-pass frames and 2 high-pass frames. Lastly, in temporal level 3, MCTF is performed forward with respect to the 2 low-pass frames obtained in temporal level 2, thereby obtaining 1 low-pass frame and 1 high-pass frame.

A process of performing MCTF on two frames and thereby obtaining a single low-pass frame and a single high-pass frame will now be described. The video encoder predicts motion between the two frames, generates a predicted frame by compensating the motion, compares the predicted frame with one frame to thereby generate a high-pass frame, and calculates the average of the predicted frame and the other frame to thereby generate a low-pass frame. As a result of MCTF, a total of 16 subbands H1, H3, H5, H7, H9, H11, H13, H15, LH2, LH6, LH10, LH14, LLH4, LLH12, LLLH8, and LLLL16 including 15 high-pass subbands and 1 low-pass subband at the last level are obtained.

Since the low-pass frame obtained at the last level is an approximation of the original frame, it is possible to generate a bitstream having temporal scalability. For example, when the bitstream is truncated in such a way as to transmit only the frame LLLL16 to a decoder, the decoder decodes the frame LLLL16 to reconstruct a video sequence with a frame rate that is one sixteenth of the frame rate of the original video sequence. When the bitstream is truncated in such a way as to transmit frames LLLL16 and LLLH8 to the decoder, the decoder decodes the frames LLLL16 and LLLH8 to reconstruct a video sequence with a frame rate that is one eighth of the frame rate of the original video sequence. In a similar fashion, the decoder reconstructs video sequences with a quarter frame rate, a half frame rate, and a full frame rate from a single bitstream.

Since scalable video coding allows generation of video sequences at various resolutions, various frames rates or various qualities from a single bitstream, this technique can be used in a wide variety of applications. However, currently known scalable video coding schemes offer significantly lower compression efficiency than other existing coding schemes such as H.264. The low compression efficiency is an important factor that severely impedes the wide use of scalable video coding. Like other compression schemes, a block-based motion model for scalable video coding cannot effectively represent a non-translatory motion, which will result in block artifacts in low-pass and high-pass subbands produced by temporal filtering and decrease the coding efficiency of the subsequent spatial transform. Block artifacts introduced in a reconstructed video sequence also hampers video quality.

Conventionally, various attempts have been made to improve the efficiency of video coding while reducing the effect of the block artifacts. One approach is to apply a technique called “deblocking” to video encoding and decoding algorithms. For example, a closed-loop H. 264 encoder performs deblocking on a reconstructed frame obtained by decoding a previously encoded frame and encodes other frames using the deblocked frame as a reference. An H. 264 decoder performs decoding of a received frame for reconstruction, deblocks the reconstructed frame, and decodes other frames using the deblocked frame as a reference.

However, deblocking cannot be applied to open-loop scalable video coding that uses an original frame as a reference frame instead of a reconstructed frame obtained by decoding a previously encoded frame. Thus, it is highly desirable to incorporate a technique similar to deblocking that improves both coding efficiency and video quality into open-loop video coding.

### SUMMARY OF THE INVENTION

The present invention provides temporal decomposition and inverse temporal decomposition methods using a smoothed predicted frame for video encoding and decoding and a video encoder and decoder.

The above stated aspect as well as other aspects, features and advantages, of the present invention will become clear to those skilled in the art upon review of the following description.

According to an aspect of the present invention, there is provided a temporal decomposition method for video encoding including: estimating the motion of a current frame using at least one frame as a reference and generating a predicted frame; smoothing the predicted frame and generating a smoothed predicted frame; and generating a residual frame by comparing the smoothed predicted frame with the current frame.

According to another aspect of the present invention, there is provided a video encoder including a temporal decomposition unit removing temporal redundancies in a current frame to generate a frame in which temporal redundancies have been removed, a spatial transformer removing spatial redundancies in the frame in which the temporal redundancies have been removed to generate a frame in which spatial redundancies have been removed, a quantizer quantizing the frame in which the spatial redundancies have been removed and generating texture information, and a bitstream generator generating a bitstream containing the texture information, wherein the temporal decomposition unit comprises a motion estimator estimating the motion of the current frame using at least one frame as a reference, a smoothed predicted frame generator generating a predicted frame using the result of motion estimation and smoothing the predicted frame to generate a smoothed predicted frame, and a residual frame generator generating a residual frame by comparing the smoothed predicted frame with the current frame.

According to still another aspect of the present invention, there is provided an inverse temporal decomposition method for video decoding, including generating a predicted frame using at least one frame obtained from a bitstream, smoothing the predicted frame and generating a smoothed predicted frame, and reconstructing a frame using a residual frame obtained from the bitstream and the smoothed predicted frame.

According to yet another aspect of the present invention, there is provided a video decoder including a bitstream interpreter interpreting a bitstream and obtaining texture information and encoded motion vectors, a motion vector decoder decoding the encoded motion vectors, an inverse quantizer performing inverse quantization on the texture information to create frames in which spatial redundancies are removed, an inverse spatial transformer performing inverse spatial transform on the frames in which the spatial redundancies have been removed and creating frames in which temporal redundancies are removed, and an inverse temporal decomposition unit reconstructing video frames from the motion vectors obtained from the motion vector decoder and the frames in which the temporal redundancies have been removed, wherein the inverse temporal decomposition unit comprises a smoothed predicted frame generator generating predicted frames using the motion vectors for frames in which the temporal redundancies have been removed and smoothing the predicted frames to generate smoothed predicted frames and a frame reconstructor reconstructing frames using the frames in which the temporal redundancies have been removed and the smoothed predicted frames.

According to another aspect of the present invention, there is provided a video encoding method including downsampling a video frame to generate a low-resolution video frame, encoding the low-resolution video frame, and encoding the video frame using information about the encoded low-resolution video frame as a reference, wherein temporal decomposition in the encoding of the video frame comprises estimating motion of the video frame using at least one frame as a reference and generating a predicted frame, smoothing the predicted frame and generating a smoothed predicted frame, and generating a residual frame by comparing the smoothed predicted frame with the video frame.

According to another aspect of the present invention, there is provided a video decoding method including reconstructing a low-resolution video frame from texture information obtained from a bitstream, and reconstructing a video frame from the texture information using the reconstructed low-resolution video frame as a reference, and wherein the reconstructing of the video frame comprises inversely quantizing the texture information to obtain a spatially transformed frame, performing inverse spatial transform on the spatially transformed frame and obtaining a frame in which temporal redundancies are removed, generating a predicted for the frame in which the temporal redundancies have been removed, smoothing the predicted frame to generate a smoothed predicted frame, and reconstructing a video frame using the frame in which the temporal redundancies have been removed and the smoothed predicted frame.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram of a conventional scalable video encoder;

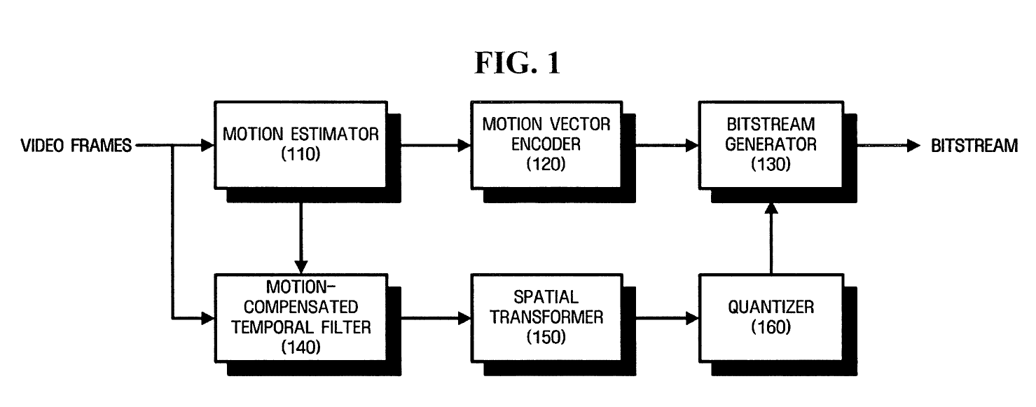

FIG. 2 illustrates a conventional temporal filtering process;

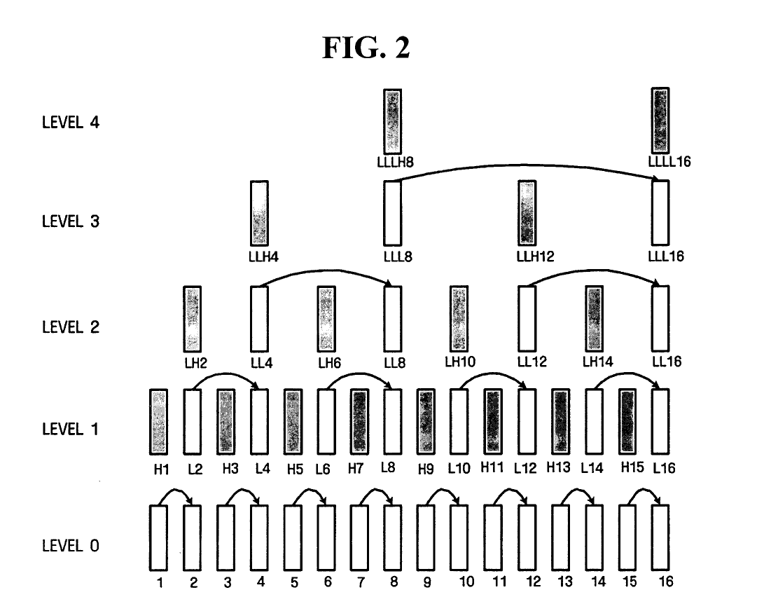

FIG. 3 is a block diagram of a video encoder according to a first embodiment of the present invention;

FIG. 4 illustrates a temporal decomposition process according to a first embodiment of the present invention;

FIG. 5 illustrates a temporal decomposition process according to a second embodiment of the present invention;

FIG. 6 illustrates a temporal decomposition process according to a third embodiment of the present invention;

FIG. 7 is a block diagram of a video decoder according to a first embodiment of the present invention;

FIG. 8 illustrates an inverse temporal decomposition process according to a first embodiment of the present invention;

FIG. 9 illustrates an inverse temporal decomposition process according to a second embodiment of the present invention;

FIG. 10 illustrates an inverse temporal decomposition process according to a third embodiment of the present invention;

FIG. 11 is a block diagram of a video encoder according to a second embodiment of the present invention; and

FIG. 12 is a block diagram of a video decoder according to a second embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

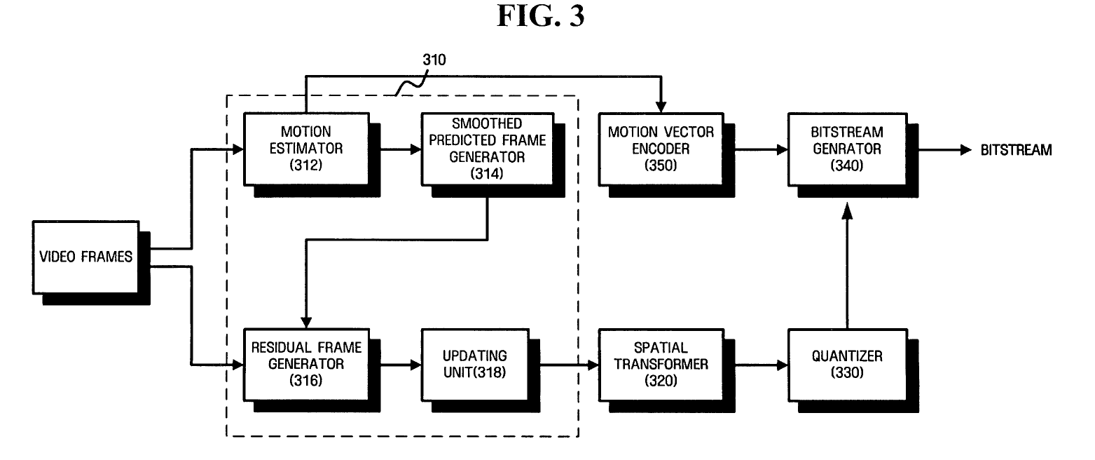

FIG. 3 is a block diagram of a video encoder according to a first embodiment of the present invention.

Although a conventional motion-compensated temporal filtering (MCTF)-based video coding scheme requires an update step, many video coding schemes not including update steps have recently been developed. While FIG. 3 shows a video encoder performing an update step, the video encoder may skip the update step.

Referring to FIG. 3, the video encoder according to a first embodiment of the present invention includes a temporal decomposition unit 310, a spatial transformer 320, a quantizer 330, and a bitstream generator 340.

The temporal decomposition unit 310 performs MCTF on input video frames on a group of picture (GOP) basis to remove temporal redundancies within the video frames. To accomplish this function, the temporal decomposition unit 310 includes a motion estimator 312 estimating motion, a smoothed predicted frame generator 314 generating a smoothed predicted frame using motion vectors obtained by the motion estimation, a residual frame generator 316 generating a residual frame (high-pass subband) using the smoothed predicted frame, and an updating unit 318 generating a low-pass subband using the residual frame.

More specifically, the motion estimator 312 determines a motion vector by calculating a displacement between each block in a current frame being subjected to temporal decomposition (hereinafter called a ‘current frame’) and a block in one or a plurality of reference frames corresponding to the block. Throughout the specification, the current frame includes an input video frame and a low-pass subband being used to generate a residual frame in a higher level.

The smoothed predicted frame generator 314 uses the motion vectors estimated by the motion estimator 312 and blocks in the reference frame to generate a predicted frame instead of directly using the predicted frame, the video encoder of the present embodiment smoothes the predicted frame and uses the smoothed predicted frame in generating a residual frame.

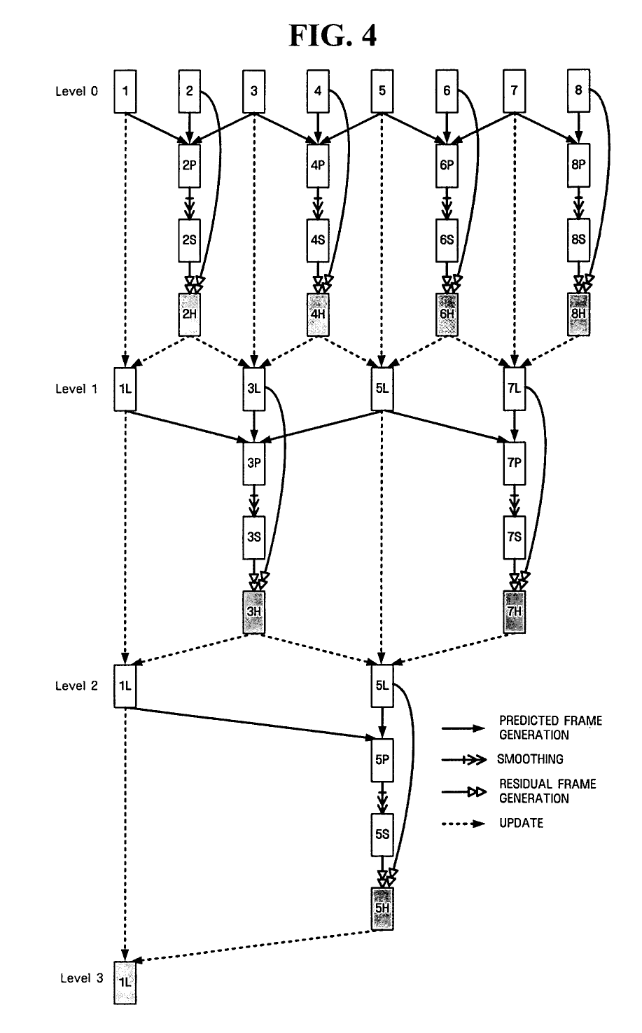

The residual frame generator 316 compares the current frame with the smoothed predicted frame to generate a residual frame (high-pass subband). The updating unit 318 uses the residual frame to update a low-pass subband. A process of generating high-pass subbands and a low-pass subband will be described later with reference to FIGS. 4-6. The frames in which temporal redundancies have been removed (the low-pass and high-pass subbands) are sent to the spatial transformer 320.

The spatial transformer 320 removes spatial redundancies within the frames in which the temporal redundancies have been removed. The spatial transform is performed using discrete cosine transform (DCT) or wavelet transform. The frames in which the spatial redundancies have been removed are sent to the quantizer 330.

The quantizer 330 applies quantization to the frames in which the spatial redundancies have been removed. Quantization for scalable video coding is performed using well-known algorithms such as Embedded ZeroTrees Wavelet (EZW), Set Partitioning in Hierarchical Trees (SPIHT), and Embedded ZeroBlock Coding (EZBC). The quantizer 330 converts the frames into texture information that is then sent to the bitstream generator 340. After quantization, the texture information has a signal-to-noise ratio (SNR) scalability.

The bitstream generator 340 generates a bitstream containing the texture information, motion vectors, and other necessary information. The motion vector encoder 350 losslessly encodes the motion vectors to be contained in the bitstream using arithmetic coding or variable length coding.

A temporal decomposition process will now be described. For convenience of explanation, a group of picture (GOP) size is assumed to be 8.

FIG. 4 illustrates a temporal decomposition process according to a first embodiment of the present invention using 5/3 MCTF. Referring to FIG. 4, the temporal decomposition using 5/3 MCTF is used to remove temporal redundancies in a current frame using immediately previous and future frames in the same level.

Frames 1 through 8 in one GOP are temporally decomposed into one low-pass subband and seven high-pass subbands. The shadowed frames in FIG. 4 are frames that are obtained as a result of temporal decomposition and will be converted into texture information after being subjected to spatial transform and quantization. P and S respectively denote a predicted frame and a smoothed predicted frame. H and L respectively denote a residual frame (high-pass subband) and a low-pass subband updated using H frames.

A temporal decomposition process involves 1) generating a predicted frame for using received eight frames making up a GOP, 2) smoothing the predicted frames, 3) generating residual frames using the smoothed predicted frames, and 4) generating a low-pass subband using the residual frames.

More specifically, a video encoder uses frame 1 and frame 3 as a reference to generate a predicted frame 2P. That is, motion estimation is required to generate the predicted frame 2P, during which a matching block corresponding to each block in frame 2 is found within the frame 1 and frame 3. Then, a mode is determined by comparing costs for encoding a block currently being subjected to motion estimation (hereinafter called a “current block”) using a block in the frame 1 (backward prediction mode), a block in the frame 3 (forward prediction mode), both blocks in the frame 1 and frame 3 (bi-directional prediction mode), respectively. Meanwhile, the current block in the frame 2 may be encoded using information from another block in the frame 2 or its own information, which is called an intra-prediction mode. After motion estimation for all blocks in the frame 2 is done, the matching blocks corresponding to the blocks in the frame 2 are gathered to generate the predicted frame 2P. Likewise, the video encoder generates predicted frames 4P, 6P, and 8P using frame 3 and frame 5, frame 5 and frame 7, and frame 7 as a reference, respectively.

The video encoder then smoothes the predicted frames 2P, 4P, 6P, and 8P to generate smoothed predicted frames 2S, 4S, 6S, and 8S, respectively. A smoothing process will be described in detail later.

The video encoder respectively compares the smoothed predicted frames 2S 4S, 6S, and 8S with the frame 2, the frame 4, the frame 6, and the frame 8, thereby obtaining residual frames 2H, 4H, 6H, and 8H.

Then, the video encoder uses the residual frame 2H to update the frame 1, thereby generating a low-pass subband 1L. The video encoder uses the residual frames 2H and 4H to update the frame 3, thereby generating a low-pass subband 3L. Similarly, the video encoder respectively uses the residual frames 4H and 6H and the residual frames 6H and 8H to generate low-pass subbands 5L and 7L.

After generating predicted frames, smoothing the predicted frames, and generating residual frames, and updating frames, frames in level 0 are decomposed into the low-pass subbands 1L, 3L, 5L, and 7L and the residual frames 2H, 4H, 6H, and 8H in level 1. In a similar fashion, after generating predicted frames, smoothing the predicted frames, and generating residual frames, and updating frames, the low-pass subbands 1L, 3L, 5L, and 7L in level 1 are decomposed into low-pass subbands 1L and 5L and residual frames 3H and 7H in level 2. Furthermore, after undergoing the same processes as the frames in level 1, the low-pass subbands 1L and 5L in level 2 are decomposed into a low-pass subband 1L and residual frame 5H in level 3.

The low-pass subband 1L and the high-pass subbands 2H, 3H, 4H, 5H, 6H, 7H, and 8H are then combined into a bitstream, following spatial transform and quantization.

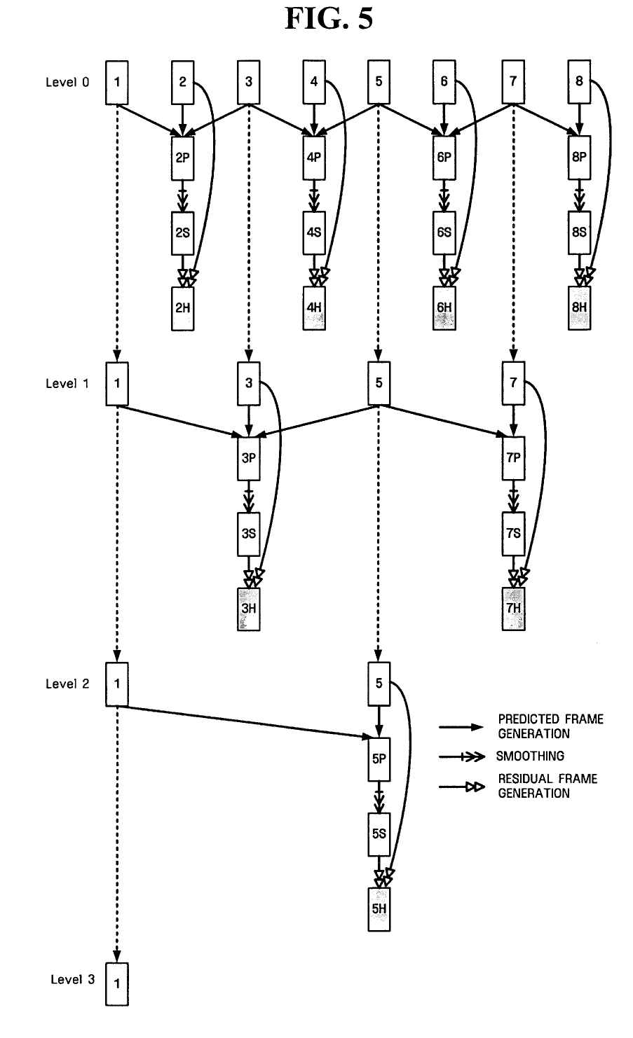

FIG. 5 illustrates a temporal decomposition process not including an update step according to a second embodiment of the present invention.

Like in the first embodiment illustrated in FIG. 4, referring to FIG. 5, a video encoder obtains residual frames 2H, 4H, 6H, and 8H in level 1 using frames 1 through 8 in level 0 through a predicted frame generation process, a smoothing process, and a residual frame generation process. However, a difference from the first embodiment is that the frames 1, 3, 5, and 7 in level 0 are used as frames 1, 3, 5, and 7 in level 1, respectively, without being updated.

Through a predicted frame generation process, a smoothing process, and a residual frame generation process, the video encoder obtains frames 1 and 5 and residual frames 3H and 7H in level 2 using the frames 1, 3, 5, and 7 in level 1. Likewise, the video encoder obtains a frame 1 and a residual frame 5H in level 3 using the frames 1 and 5 in level 2.

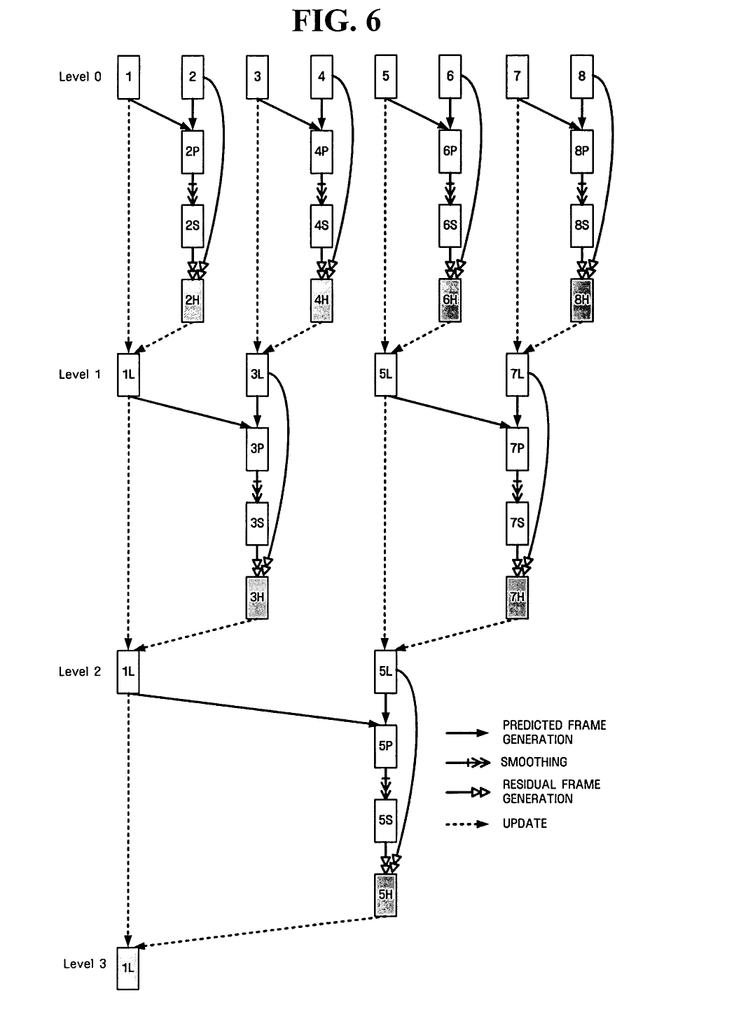

FIG. 6 illustrates a temporal decomposition process using a Haar filter according to a third embodiment of the present invention.

Like in the first embodiment shown in FIG. 4, a video decoder uses all processes, i.e., a predicted frame generation process, a smoothing process, a residual frame generation process, and an update process. However, the difference from the first embodiment is that a predicted frame is generated using only one frame as a reference. Thus, the video encoder can use either forward or backward prediction mode. That is, the encoder may not select a different prediction mode for each block (e.g., forward prediction for one block and backward prediction for another block) nor a bi-directional prediction mode.

In the present embodiment, the video encoder uses a frame 1 as a reference to generate a predicted frame 2P, smoothes the predicted frame 2P to obtain a smoothed predicted frame 2S, and compares the smoothed predicted frame 2S with a frame 2 to generate a residual frame 2H. In the same manner, the video encoder obtains other residual frames 4H, 6H, and 8H. Furthermore, the video encoder uses the residual frames 2H and 4H to update the frame 1 and the frame 3 in level 0, thereby generating low-pass subbands 1L and 3L in level 1, respectively. Similarly, the video encoder obtains low-pass subbands 5L and 7L in level 1.

Through a predicted frame generation process, a smoothing process, and residual frame generation process, and an update process, the video encoder obtains low-pass subbands 1L and 5L and residual frames 3H and 5H in level 2 using the low-pass subbands 1L, 3L, 5L, and 7L. Finally, the video encoder obtains a low-pass subband 1L and a residual frame 5H in level 3 using the low-pass subbands 1L and 5L in level 2.

A smoothing process included in the embodiments illustrated in FIGS. 4-6 will now be described.

The smoothing process is performed on a predicted frame. While no block artifact is present in an original video frame, block artifacts are introduced in a predicted frame. Thus, block artifacts will be present in a residual frame obtained from the predicted frame and a low-pass subband obtained using the residual frame. To reduce the block artifacts, the predicted frame is smoothed. The video encoder performs a smoothing process by deblocking a boundary between blocks in the predicted frame. Deblocking of a boundary between blocks in a frame is also used in the H.264 video coding standard. Since a deblocking technique is widely known in video coding applications, the description thereof will not be given.

A deblocking strength can be determined according to the degree of blocking. The deblocking strength can be determined upon several principles.

For example, a deblocking strength for a boundary between blocks in a predicted frame obtained by motion estimation between frames with a large temporal distance can be made higher than that between blocks in a predicted frame obtained by motion estimation between frames with a small temporal distance. For example, referring to FIG. 4, a temporal distance between the current frame and reference frame in level 0 is 1 while a temporal distance between the current frame and reference frame in level 1 is 2. In the embodiments illustrated in FIGS. 4-6, a deblocking strength for a predicted frame obtained at a higher level is higher than that for a predicted frame obtained at a lower level. There are various approaches to determining a deblocking strength according to a level. One example is to linearly determine a deblocking strength as defined by Equation (1):
D=D1+D2*T (1)
where D is a deblocking strength and D1 is a default deblocking strength that may vary according to a video encoding environment. For example, since a large number of block artifacts may occur at low bit-rate, the default deblocking strength D is large for the low bit-rate environment. D2 is an offset value for a deblocking strength for each level and T is a level. For example, deblocking strengths D at level 0 and level 2 are D1 and D1+D2*2, respectively.

A deblocking strength can also be determined according to a mode selected for each block in a predicted frame. A deblocking strength for a boundary between blocks predicted using different prediction modes is made higher than that for a boundary between blocks predicted using the same prediction mode.

A deblocking strength for a boundary between blocks with a large motion vector difference is made higher than that for a boundary between blocks with a small motion vector difference.

When a predicted frame is deblocked with varying strengths according to the above principles, information about the deblocking strength is contained in a bitstream. A decoder smoothes a predicted frame by deblocking the predicted frame with the same deblocking strength as the encoder and reconstructs video frames using the smoothed predicted frame.

To compare the performance of video coding using a smoothed predicted frame, the inventors of the present invention conducted experiments in which an H.264 deblocking filter module is applied to a conventional scalable video encoder. A deblocking strength in the H.264 deblocking filter module is dependent on a quantization parameter (QP). When a QP for a default deblocking strength is set to 30 and a QP for SOCCER is set to 35, the results of experiments are as follows:

Test 1 sequences

| | | | | | | Embodiment of the present | | | | |
|---|---|---|---|---|---|---|---|---|---|---|
| Microsoft video encoder | | | | | | invention | | | | |
| | | Y | U | V | Avg | Y | U | V | Avg | PSNR |
| | Layer | PSNR | PSNR | PSNR | PSNR | PSNR | PSNR | PSNR | PSNR | diff. |
| CITY | 0 | 29.41 | 40.04 | 40.88 | 33.09 | 29.43 | 40.07 | 40.86 | 33.11 | 0.01 |
| | 1 | 32.29 | 41.59 | 43.64 | 35.73 | 32.32 | 41.63 | 43.66 | 35.76 | 0.03 |
| | 2 | 29.18 | 40.72 | 42.72 | 33.36 | 29.20 | 40.73 | 42.72 | 33.37 | 0.01 |
| | 3 | 31.51 | 41.59 | 43.48 | 35.18 | 31.53 | 41.58 | 43.47 | 35.19 | 0.01 |
| | 4 | 32.69 | 41.71 | 43.80 | 36.04 | 32.70 | 41.48 | 43.73 | 36.00 | −0.05 |
| | 5 | 35.06 | 43.15 | 45.06 | 38.08 | 35.02 | 42.72 | 44.90 | 37.95 | −0.13 |
| CREW | 0 | 31.27 | 35.52 | 33.85 | 32.41 | 31.30 | 35.79 | 34.01 | 32.50 | 0.09 |
| | 1 | 33.68 | 37.99 | 36.26 | 34.83 | 33.71 | 38.10 | 36.29 | 34.87 | 0.05 |
| | 2 | 32.65 | 37.45 | 36.06 | 34.02 | 32.71 | 37.73 | 36.28 | 34.14 | 0.12 |
| | 3 | 34.77 | 39.30 | 38.21 | 36.10 | 34.82 | 39.50 | 38.44 | 36.20 | 0.11 |
| | 4 | 35.40 | 39.76 | 39.56 | 36.82 | 35.47 | 39.99 | 39.89 | 36.96 | 0.14 |
| | 5 | 36.87 | 40.48 | 40.99 | 38.16 | 36.95 | 40.70 | 41.28 | 38.30 | 0.14 |
| HARBOUR | 0 | 27.98 | 38.51 | 39.06 | 31.58 | 27.98 | 38.56 | 39.30 | 31.63 | 0.05 |
| | 1 | 30.99 | 40.46 | 42.62 | 34.51 | 31.00 | 40.36 | 42.61 | 34.50 | −0.01 |
| | 2 | 28.67 | 39.22 | 41.46 | 32.56 | 28.69 | 39.23 | 41.35 | 32.55 | 0.00 |
| | 3 | 31.17 | 40.72 | 42.75 | 34.69 | 31.19 | 40.62 | 42.68 | 34.67 | −0.01 |
| | 4 | 32.18 | 41.31 | 43.28 | 35.55 | 32.18 | 41.27 | 43.28 | 35.55 | −0.01 |
| | 5 | 34.42 | 43.04 | 45.20 | 37.65 | 34.42 | 42.90 | 45.12 | 37.62 | −0.03 |
| SOCCER | 0 | 31.02 | 37.74 | 39.93 | 33.63 | 31.06 | 37.91 | 40.23 | 33.73 | 0.10 |
| | 1 | 33.44 | 40.09 | 41.55 | 35.90 | 33.46 | 40.04 | 41.74 | 35.94 | 0.04 |
| | 2 | 31.76 | 39.44 | 41.10 | 34.60 | 31.79 | 39.62 | 41.34 | 34.69 | 0.09 |
| | 3 | 33.99 | 41.25 | 43.08 | 36.71 | 33.98 | 41.34 | 43.38 | 36.77 | 0.06 |
| | 4 | 34.84 | 41.68 | 43.50 | 37.42 | 34.85 | 41.87 | 43.74 | 37.50 | 0.08 |
| | 5 | 36.95 | 43.22 | 44.96 | 39.33 | 36.93 | 43.26 | 45.16 | 39.35 | 0.03 |

Test 2 sequences

| | | | | | | Embodiment of the present | | | | |
|---|---|---|---|---|---|---|---|---|---|---|
| Microsoft video encoder | | | | | | invention | | | | |
| | | Y | U | V | Avg | Y | U | V | Avg | PSNR |
| | Layer | PSNR | PSNR | PSNR | PSNR | PSNR | PSNR | PSNR | PSNR | diff. |
| BUS | 0 | 25.90 | 36.19 | 36.65 | 29.41 | 25.98 | 36.08 | 36.43 | 29.40 | 0.00 |
| | 1 | 26.24 | 36.37 | 37.42 | 29.79 | 26.27 | 36.49 | 37.53 | 29.85 | 0.06 |
| | 2 | 27.35 | 37.01 | 37.72 | 30.69 | 27.39 | 37.07 | 37.79 | 30.74 | 0.05 |
| | 3 | 30.31 | 38.60 | 39.90 | 33.29 | 30.36 | 38.60 | 39.98 | 33.33 | 0.04 |
| | 4 | 30.85 | 39.11 | 40.47 | 33.83 | 30.89 | 39.07 | 40.45 | 33.85 | 0.01 |
| FOOTB | 0 | 30.21 | 34.34 | 36.74 | 31.99 | 30.29 | 34.80 | 37.23 | 32.20 | 0.21 |
| | 1 | 29.41 | 33.67 | 36.43 | 31.29 | 29.50 | 34.25 | 37.06 | 31.55 | 0.26 |
| | 2 | 30.98 | 34.94 | 37.29 | 32.69 | 31.11 | 35.64 | 37.79 | 32.97 | 0.29 |
| | 3 | 32.32 | 36.02 | 38.21 | 33.92 | 32.46 | 36.76 | 38.80 | 34.23 | 0.31 |
| | 4 | 34.01 | 37.44 | 39.47 | 35.49 | 34.18 | 38.21 | 40.05 | 35.83 | 0.34 |
| FOREM | 0 | 29.22 | 36.62 | 36.49 | 31.66 | 29.28 | 36.79 | 36.24 | 31.69 | 0.03 |
| | 1 | 29.77 | 36.63 | 37.15 | 32.15 | 29.79 | 37.04 | 37.34 | 32.26 | 0.11 |
| | 2 | 30.82 | 37.46 | 38.10 | 33.14 | 30.91 | 37.49 | 38.14 | 33.21 | 0.07 |
| | 3 | 33.49 | 39.29 | 40.33 | 35.60 | 33.60 | 39.28 | 40.43 | 35.68 | 0.09 |
| | 4 | 34.23 | 39.62 | 40.85 | 36.23 | 34.33 | 39.64 | 40.89 | 36.30 | 0.07 |
| MOBILE | 0 | 22.76 | 26.79 | 26.05 | 23.98 | 22.78 | 26.79 | 25.92 | 23.97 | −0.01 |
| | 1 | 23.24 | 27.53 | 26.85 | 24.55 | 23.25 | 27.65 | 26.79 | 24.57 | 0.02 |
| | 2 | 23.70 | 28.52 | 28.08 | 25.23 | 23.72 | 28.47 | 28.10 | 25.24 | 0.01 |
| | 3 | 26.83 | 31.35 | 30.74 | 28.24 | 26.87 | 31.32 | 30.78 | 28.26 | 0.03 |
| | 4 | 28.57 | 32.74 | 32.35 | 29.90 | 28.62 | 32.65 | 32.35 | 29.91 | 0.02 |

As evident from the results of experiments, video encoding according to the embodiment of the present invention provides improved video quality over the conventional scalable video encoding.

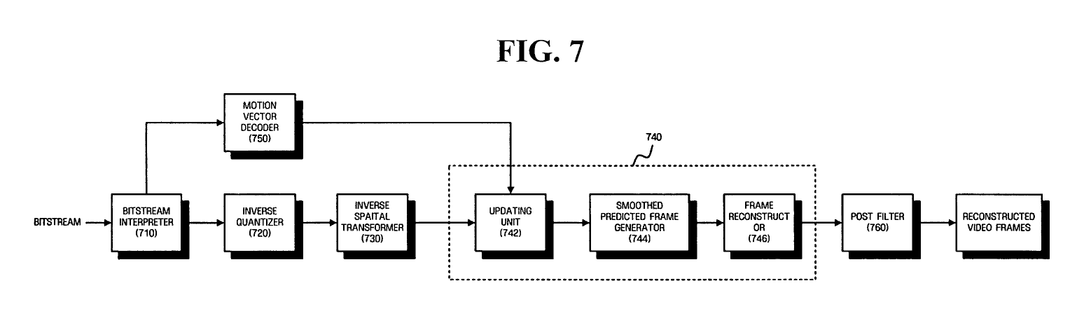

FIG. 7 is a block diagram of a video decoder according to an embodiment of the present invention. Basically, the video decoder performs the inverse operation of an encoder. Thus, while the video encoder removes temporal and spatial redundancies within video frames to generate a bitstream, the video decoder restores spatial and temporal redundancies from a bitstream to reconstruct video frames.

The video decoder includes a bitstream interpreter 710 interpreting an input bitstream to obtain texture information and encoded motion vectors, an inverse quantizer 720 inversely quantizing the texture information and creating frames in which spatial redundancies are removed, an inverse spatial transformer 730 performing inverse spatial transform on the frames in which the spatial redundancies have been removed and creating frames in which temporal redundancies are removed, an inverse temporal decomposition unit 740 performing inverse temporal decomposition on the frames in which the temporal redundancies have been removed and reconstructing video frames, and a motion vector decoder 750 decoding the encoded motion vectors. While the video decoding involves a smoothing process for smoothing a predicted frame, the video decoder further includes a post filter 760 deblocking the reconstructed video frames.

To reconstruct video frames from frames (low-pass and high-pass subbands) in which temporal redundancies have been removed, the inverse temporal decomposition unit 740 includes an updating unit 742, a smoothed predicted frame generator 744, and a frame reconstructor 746.

The updating unit 742 uses a high-pass subband to update a low-pass subband, thereby generating a low-pass subband in a lower level. The smoothed predicted frame generator 744 uses the low-pass subband obtained by updating to generate a predicted frame and smoothes the predicted frame. The frame reconstructor 746 uses the smoothed predicted frame and the high-pass subband to generate a low-pass subband in a lower level or reconstruct a video frame.

The post filter 760 reduces the effect of block artifacts by deblocking a reconstructed frame. Information about post-filtering performed by the post filter 760 is provided by an encoder. That is, information determining whether to perform post-filtering on the reconstructed video frame is contained in a bitstream.

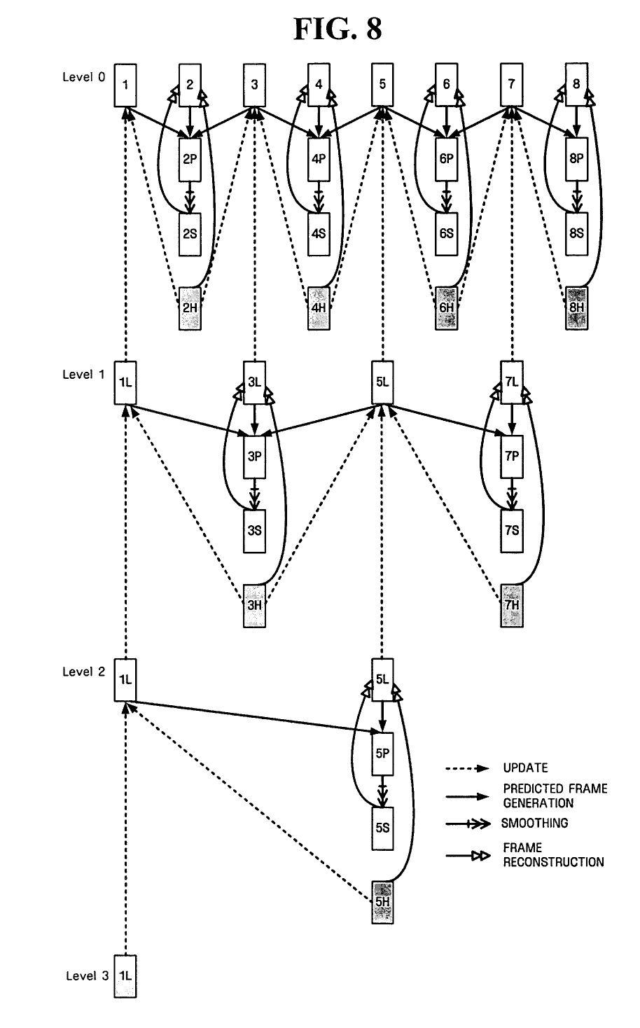

An inverse temporal decomposition process will now be described with reference to FIGS. 8-10. For convenience of explanation, a GOP size is assumed to be 8.

FIG. 8 illustrates an inverse temporal decomposition process using 5/3 MCTF according to a first embodiment of the present invention. The inverse temporal decomposition process using 5/3 MCTF is performed to reconstruct a frame (a low-pass subband or video frame) using reconstructed frames immediately before and after a residual frame, i.e., immediately previous reconstructed frame (a low-pass subband or reconstructed video frame) and immediately next reconstructed frame.

The inverse temporal decomposition is performed for each GOP including one low-pass subband and seven high-pass subbands. That is, a video decoder receives one low-pass subband and seven high-pass subbands to reconstruct 8 video frames. In FIG. 8, shadowed frames are frames obtained as a result of inverse spatial transform, P and S respectively denote a predicted frame and a smoothed predicted frame, and H and L respectively denote a residual frame (high-pass subband) and a low-pass subband.

An inverse temporal decomposition process includes 1) updating received eight subbands in the reverse order that encoding is performed, 2) generating predicted frames, 3) smoothing the predicted frames, and 4) generating low-pass subbands using the smoothed predicted frames or reconstructing video frames.

The video decoder uses a residual frame 5H to update a low-pass subband 1L in level 3 in the reverse order that encoding is performed, thereby generating a low-pass subband 1L in level 2. The video decoder then uses the low-pass subband 1L in level 2 and motion vectors to generate a predicted frame 5P and smoothes the predicted frame 5P to generate a smoothed predicted frame 5S. Thereafter, the video decoder uses the smoothed predicted frame 5S and the residual frame 5H to reconstruct a low-pass subband 5L in level 2.

Likewise, through an updating process, a predicted frame generation process, a smoothing process, and a frame reconstruction process, the video decoder reconstructs low-pass subbands 1L, 3L, 5L, and 7L in level 1 using the low-pass subbands 1L and 5L and residual frames 3H and 7H in level 2. Lastly, the video decoder uses the low-pass subbands 1L, 3L, 5L, and 7L and residual frames 2H, 4H, 6H, and 8H in level 1 to reconstruct video frames 1 through 8. Meanwhile, when further needed according to the information contained in the bitstream, post filtering is performed on the video frames 1 through 8.

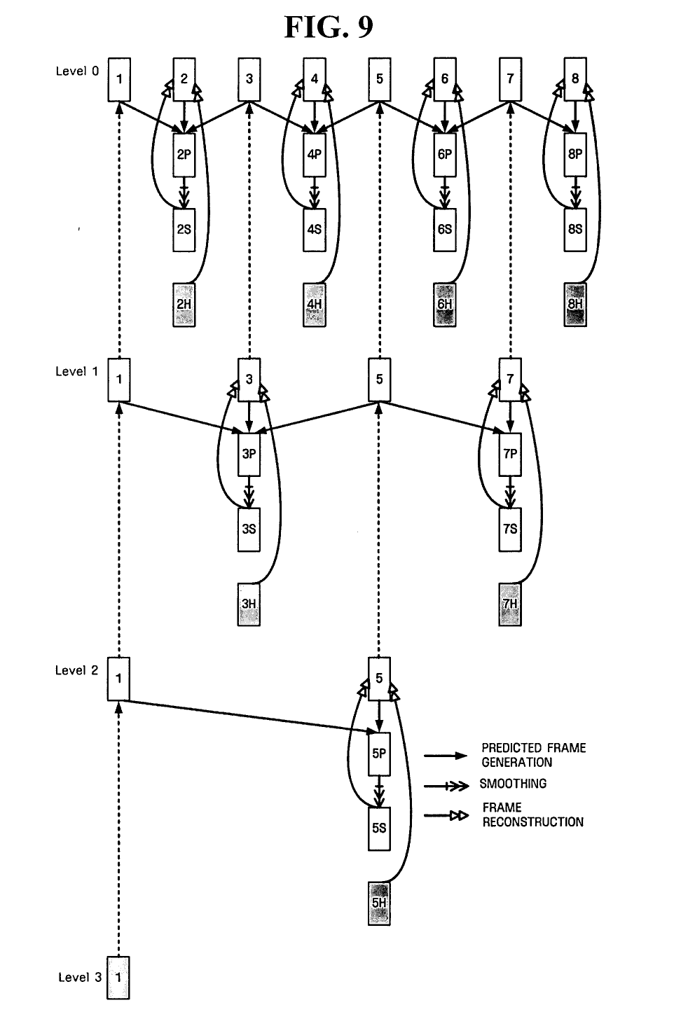

FIG. 9 illustrates an inverse temporal decomposition process according to a second embodiment of the present invention.

Unlike the first embodiment shown in FIG. 8, the inverse temporal decomposition process according to the present embodiment does not include an update step.

Referring to FIG. 9, a video frame 1 in level 3 is the same as reconstructed video frames 1 in levels 2, 1, and 0. Similarly, a video frame 5 in level 2 is the same as reconstructed video frames 5 in levels 1 and 0, and video frames 3 and 7 in level 1 are the same as video frames 3 and 7 in level 0.

Through a predicted frame generation process, a smoothing process, and a frame reconstruction process, the video decoder reconstructs a video frame 5 in level 2 using a video frame 1 and a residual frame 5H in level 3. Likewise, the video decoder reconstructs video frames 3 and 7 in level 1 using reconstructed video frames 1 and 5 and residual frames 3H and 7H in level 2. Lastly, the video decoder reconstructs video frames 1 through 8 in level 0 using reconstructed video frames 1, 3, 5, and 7 and residual frames 2H, 4H, 6H, and 8H level 1.

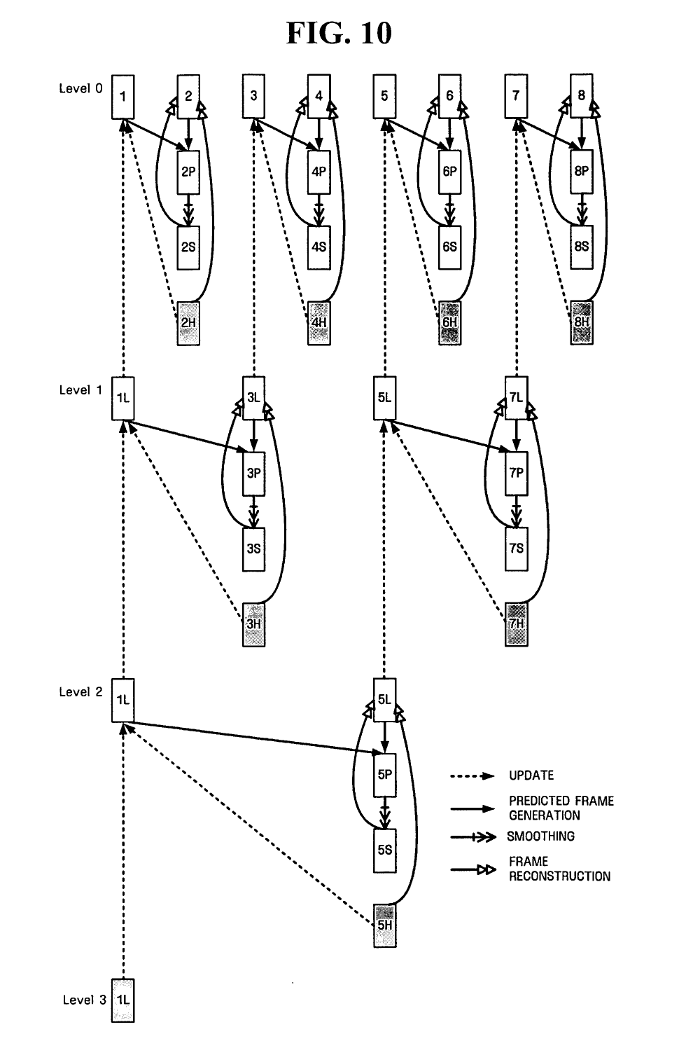

FIG. 10 illustrates an inverse temporal decomposition process using a Haar filter according to a third embodiment of the present invention.

Like in the first embodiment illustrated in FIG. 8, a video decoder uses all processes, i.e., an update process, a predicted frame generation process, a smoothing process, and a frame reconstruction process. However, the difference from the first embodiment is that a predicted frame is generated using only one frame as a reference. Thus, the video decoder can use either forward or backward prediction mode.

Referring to FIG. 10, through an update process, a predicted frame generation process, a smoothing process, and a frame reconstruction process, the video decoder uses a low-pass subband 1L and a residual frame 5H in level 3 to reconstruct low-pass subbands 1L and 5L in level 2. Then, the video decoder uses the reconstructed low-pass subbands 1L and 5L and residual frames 3H and 7H in level 2 to reconstruct low-pass subbands 1L, 3L, 5L, and 7L in level 1. Lastly, the video decoder uses the low-pass subbands 1L, 3L, 5L, and 7L and residual frames 2H, 4H, 6H, and 8H to reconstruct video frames 1 through 8.

A smoothing process performed in the embodiments shown in FIGS. 8-10 is performed according to the same principle as an encoding process. Thus, a deblocking strength increases when a temporal distance between a reference frame and a predicted frame increases. Furthermore, a deblocking strength for blocks predicted using a different motion estimation mode or having a large motion vector difference is high. Information about a deblocking strength can be obtained from a bitstream.

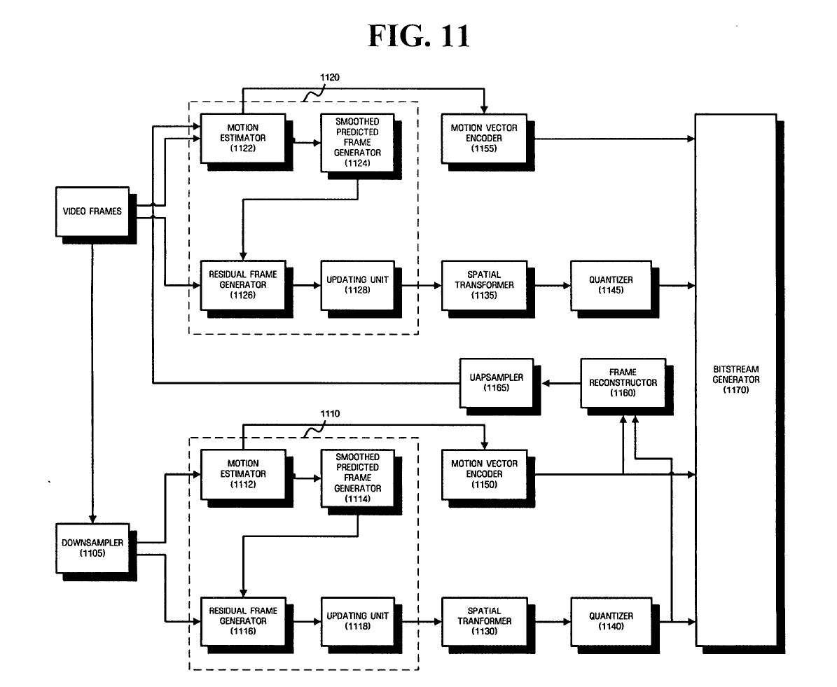

FIG. 11 is a block diagram of a video encoder according to a second embodiment of the present invention.

The video encoder is a multi-layer encoder having layers with different resolutions.

Referring to FIG. 11, the video encoder includes a downsampler 1105, a first temporal decomposition unit 1110, a first spatial transformer 1130, a first quantizer 1140, a frame reconstructor 1160, an upsampler 1165, a second temporal decomposition unit 1120, a second spatial transformer 1135, a second quantizer 1145, and a bitstream generator 1170.

The downsampler 1105 downsamples video frames to generate low-resolution video frames that are then provided to the first temporal decomposition unit 1110.

The first temporal decomposition unit 1110 performs MCTF on the low-resolution video frames on a GOP basis to remove temporal redundancies in the low-resolution video frames. To accomplish this function, the first temporal decomposition unit 1110 includes a motion estimator 1112 estimating motion, a smoothed predicted frame generator 1114 generating a smoothed predicted frame using motion vectors obtained by the motion estimation, a residual frame generator 1116 generating a residual frame (high-pass subband) using the smoothed predicted frame, and an updating unit 1118 generating a low-pass subband using the residual frame.

More specifically, the motion estimator 1112 determines a motion vector by calculating a displacement between each block in a low-resolution video frame being encoded and a block in one or a plurality of reference frames corresponding to the block. The smoothed predicted frame generator 1114 uses the motion vectors estimated by the motion estimator 1112 and blocks in the reference frame to generate a predicted frame. Instead of directly using the predicted frame, the present embodiment smoothes the predicted frame and uses the smoothed predicted frame in generating a residual frame.

The residual frame generator 1116 compares the low-resolution video frame with the smoothed predicted frame to generate a residual frame (high-pass subband). The updating unit 1118 uses the residual frame to update a low-pass subband. The low-resolution video frames in which temporal redundancies have been removed (the low-pass and high-pass subbands) are then sent to the first spatial transformer 1130.

The first spatial transformer 1130 removes spatial redundancies within the frames in which the temporal redundancies have been removed. The spatial transform is performed using discrete cosine transform (DCT) or wavelet transform. The frames in which spatial redundancies have been removed using the spatial transform are sent to the first quantizer 1140.

The first quantizer 1140 applies quantization to the low-resolution video frames in which the spatial redundancies have been removed. After quantization, the low-resolution video frames are converted into texture information that is then sent to the bitstream generator 1170.

The motion vector encoder 1150 encodes the motion vectors obtained during motion estimation in order to reduce the number of bits required for the motion vectors.

The frame reconstructor 1160 performs inverse quantization and inverse spatial transform on the quantized low-resolution frames, 1 followed by inverse temporal decomposition using motion vectors, thereby reconstructing low-resolution video frames. The upsampler 1165 upsamples the reconstructed low-resolution video frames. The upsampled video frames are used as a reference in compressing video frames.

The second temporal decomposition unit 1120 performs MCTF on input video frames on a GOP basis to remove temporal redundancies in the video frames.

To accomplish this function, the second temporal decomposition unit 1120 includes a motion estimator 1122 estimating motion, a smoothed predicted frame generator 1124 generating a smoothed predicted frame using motion vectors obtained by the motion estimation, a residual frame generator 1126 generating a residual frame (high-pass subband) using the smoothed predicted frame, and an updating unit 1128 generating a low-pass subband using the residual frame.

The motion estimator 1122 obtains a motion vector by calculating a displacement between each block in a video frame currently being encoded and a block in one or a plurality of reference frames corresponding to the block or determines whether to use each block in the upsampled frame obtained by the upsampler 1165.

The smoothed predicted frame generator 1124 uses blocks in the reference frame and the upsampled frame to generate a predicted frame. Instead of directly using the predicted frame, the video encoder of the present embodiment smoothes the predicted frame and uses the smoothed predicted frame in generating a residual frame.

The residual frame generator 1126 compares the smoothed predicted frame with the video frame to generate a residual frame (high-pass subband). The updating unit 1128 uses the residual frame to update a low-pass subband. The video frames in which temporal redundancies have been removed (the low-pass and high-pass subbands) are then sent to the second spatial transformer 1135.

The second spatial transformer 1135 removes spatial redundancies within the frames in which the temporal redundancies have been removed. The spatial transform is performed using discrete cosine transform (DCT) or wavelet transform. The frames in which spatial redundancies have been removed using the spatial transform are sent to the second quantizer 1145.

The second quantizer 1145 applies quantization to the video frames in which the spatial redundancies have been removed. After quantization, the video frames are converted into texture information that is then sent to the bitstream generator 1170.

The motion vector encoder 1155 encodes the motion vectors obtained during motion estimation in order to reduce the number of bits required for the motion vectors.

The bitstream generator 1170 generates a bitstream containing the texture information and motion vectors associated with the low-resolution video frames and original-resolution video frames and other necessary information.

While FIG. 11 shows the multi-layer video encoder having two layers of different resolutions, the video encoder may have three or more layers of different resolutions.

A multi-layer video encoder performing different video coding schemes at the same resolution may also be implemented in the same way as in FIG. 11. For example, when first and second spatial transformers 1130 and 1135 respectively adopt DCT and wavelet transform, the multi-layer video encoder having layers of the same resolution does not require the downsampler 1105 nor the upsampler 1165.

Alternatively, the multi-layer video encoder of FIG. 11 may be implemented such that either one of the first and second temporal transformers 1110 and 1120 generates a smoothed predicted frame and the other generates a typical predicted frame.

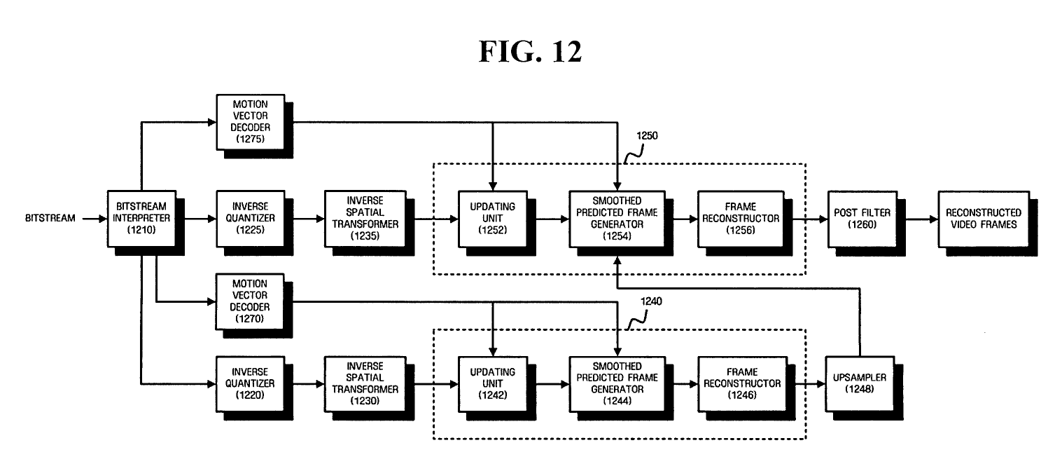

FIG. 12 shows the configuration of a video decoder according to a second embodiment of the present invention as the counterpart of the video encoder of FIG. 11. The video decoder may also be configured to reconstruct video frames from a bitstream encoded by the modified multi-layer video encoder described above.

Referring to FIG. 12, the video decoder includes a bitstream interpreter 1210 interpreting an input bitstream to obtain texture information and encoded motion vectors, first and second inverse quantizers 1220 and 1225 inversely quantizing the texture information and creating frames in which spatial redundancies are removed, first and second inverse spatial transformers 1230 and 1235 performing inverse spatial transform on the frames in which the spatial redundancies are removed and creating frames in which temporal redundancies are removed, first and second inverse temporal decomposition units 1240 and 1250 performing inverse temporal decomposition on the frames in which the temporal redundancies have been removed and reconstructing video frames, and motion vector decoders 1270 and 1275 decoding the encoded motion vectors. The video decoding involves a smoothing process for smoothing a predicted frame, and the video decoder further includes a post filter 1260 deblocking the reconstructed video frames.

While FIG. 12 shows that both the first and second inverse temporal decomposition units 1240 and 1250 generate smoothed predicted frames, either one of the first and second inverse temporal decomposition units 1240 and 1250 may generate a typical predicted frame.

The first inverse quantizer 1220, the first inverse spatial transformer 1230, and the first inverse decomposition unit 1240 reconstruct low-resolution video frames, and the upsampler 1248 upsamples the reconstructed low-resolution video frames.

The second inverse quantizer 1225, the second inverse spatial transformer 1235, and the second inverse temporal decomposition unit 1250 reconstructs video frames using an upsampled frame obtained by the upsampler 1248 as a reference.

As described above, when a video frame is reconstructed from a bitstream encoded using different video coding schemes at the same resolution, the video decoder does not require the upsampler 1248.

As described above, the temporal decomposition and inverse temporal decomposition methods according to the present invention allow smoothing of predicted frame during open-loop scalable video encoding and decoding, thereby improving image quality and coding efficiency for video coding.

The above embodiments and drawings are to be considered in all aspects as illustrative and not restrictive. Therefore, the scope and spirit of the present invention are indicated by the appended claims, rather than by the foregoing description.

What is claimed is:

1. A temporal decomposition method for video encoding, comprising:
estimating motion of a current frame using at least one frame as a reference and generating a predicted frame;
smoothing the predicted frame and generating a smoothed predicted frame; and
generating a residual frame by comparing the smoothed predicted frame with the current frame.

2. The method of claim 1, wherein the reference frames are frames in the same level immediately before and after the current frame.

3. The method of claim 1, further comprising updating the reference frames using the residual frame.

4. The method of claim 1, wherein the smoothed predicted frame is generated by deblocking a boundary between blocks in the predicted frame.

5. The method of claim 4, wherein the strength of deblocking increases as a temporal distance between the current frame and one of the reference frames increases.

6. The method of claim 4, wherein the strength of deblocking is high when the blocks in the predicted frame are predicted using different prediction modes or have a large motion vector difference.

7. A video encoder comprising:
a temporal decomposition unit removing temporal redundancies in a current frame to generate a frame in which temporal redundancies have been removed;
a spatial transformer removing spatial redundancies in the frame in which the temporal redundancies have been removed to generate a frame in which spatial redundancies have been removed;
a quantizer quantizing the frame in which the spatial redundancies have been removed and generating texture information; and
a bitstream generator generating a bitstream containing the texture information, wherein the temporal decomposition unit comprises a motion estimator estimating the motion of the current frame using at least one frame as a reference, a smoothed predicted frame generator generating a predicted frame using the result of motion estimation and smoothing the predicted frame to generate a smoothed predicted frame, and a residual frame generator generating a residual frame in which the temporal redundancies have been removed by comparing the smoothed predicted frame with the current frame.

8. The encoder of claim 7, wherein the reference frames referred by the motion estimator are frames in the same level immediately before and after the current frame.

9. The encoder of claim 7, wherein the temporal decomposition unit further comprises an updating unit updating the reference frame using the residual frame in which the temporal redundancies have been removed.

10. The encoder of claim 7, wherein the smoothed predicted frame generator generates the smoothed predicted frame by deblocking a boundary between blocks in the predicted frame.

11. The encoder of claim 10, wherein the smoothed predicted frame generator deblocks the boundary between blocks in the predicted frame by increasing the strength of deblocking according to a temporal distance between the current frame and one of the reference frames.

12. The encoder of claim 10, wherein the smoothed predicted frame generator deblocks the boundary between blocks in the predicted frame when the blocks in the predicted frame are predicted using different prediction modes or have a large motion vector difference.

13. An inverse temporal decomposition method for video decoding, comprising:
generating a predicted frame using at least one frame obtained from a bitstream as a reference;
smoothing the predicted frame and generating a smoothed predicted frame; and
reconstructing a frame using a residual frame obtained from the bitstream and the smoothed predicted frame.

14. The method of claim 13, wherein the reference frames are reconstructed frames immediately before and after the residual frame.

15. The method of claim 13, wherein the reference frames are frames updated using a residual frame before generating of the predicted frame.

16. The method of claim 13, wherein the smoothed predicted frame is generated by deblocking a boundary between blocks in the predicted frame.

17. The method of claim 16, wherein the strength of deblocking is obtained from the bitstream.

18. A video decoder comprising:
a bitstream interpreter interpreting a bitstream and obtaining texture information and encoded motion vectors;
a motion vector decoder decoding the encoded motion vectors;
an inverse quantizer performing inverse quantization on the texture information to create frames in which spatial redundancies are removed;
an inverse spatial transformer performing inverse spatial transform on the frames in which the spatial redundancies have been removed and creating frames in which temporal redundancies are removed; and
an inverse temporal decomposition unit reconstructing video frames from the motion vectors obtained from the motion vector decoder and the frames in which the temporal redundancies have been removed,
wherein the inverse temporal decomposition unit comprises a smoothed predicted frame generator generating predicted frames using the motion vectors for frames in which the temporal redundancies have been removed and smoothing the predicted frames to generate smoothed predicted frames and a frame reconstructor reconstructing frames using the frames in which the temporal redundancies have been removed and the smoothed predicted frames.

19. The decoder of claim 18, wherein the smoothed predicted frame generator generates the predicted frame by referring reconstructed frames immediately before and after the residual frame.

20. The decoder of claim 18, wherein the inverse temporal decomposition unit further comprises an updating unit updating at least one reconstructed frame being used in generating the predicted frames for the corresponding residual frames.

21. The decoder of claim 18, wherein the smoothed predicted frame generator generates the smoothed predicted frame by deblocking a boundary between blocks in the predicted frame.

22. The decoder of claim 21, wherein the strength of deblocking is obtained from the bitstream.

23. A video encoding method comprising:
downsampling a video frame to generate a low-resolution video frame;
encoding the low-resolution video frame; and
encoding the video frame using information about the encoded low-resolution video frame as a reference;
wherein temporal decomposition in the step of encoding of the video frame comprises estimating motion of the video frame using at least one frame as a reference, generating a smoothed predicted frame by smoothing the predicted frame, and generating a residual frame by comparing the smoothed predicted frame with the video frame.

24. A video decoding method comprising:
reconstructing a low-resolution video frame from texture information obtained from a bitstream; and
reconstructing a video frame from the texture information using the reconstructed low-resolution video frame as a reference, and
wherein the step of reconstructing the video frame comprises inversely quantizing the texture information to obtain a spatially transformed frame, performing inverse spatial transform on the spatially transformed frame and obtaining a frame in which temporal redundancies are removed, generating a predicted frame for the frame in which the temporal redundancies have been removed, smoothing the predicted frame to generate a smoothed predicted frame, and reconstructing a video frame using the frame in which the temporal redundancies have been removed and the smoothed predicted frame.

25. A recording medium having a computer readable program recorded therein, the program for executing a temporal decomposition method for video encoding, the method comprising:
estimating motion of a current frame using at least one frame as a reference and generating a predicted frame;
smoothing the predicted frame and generating a smoothed predicted frame; and
generating a residual frame by comparing the smoothed predicted frame with the current frame.

26. A recording medium having a computer readable program recorded therein, the program for executing an inverse temporal decomposition method for video decoding, the method comprising:
generating a predicted frame using at least one frame obtained from a bitstream as a reference;
smoothing the predicted frame and generating a smoothed predicted frame; and
reconstructing a frame using a residual frame obtained from the bitstream and the smoothed predicted frame.

27. A recording medium having a computer readable program recorded therein, the program for executing a video encoding method, the method comprising:
downsampling a video frame to generate a low-resolution video frame;
encoding the low-resolution video frame; and
encoding the video frame using information about the encoded low-resolution video frame as a reference;
wherein temporal decomposition in the step of encoding of the video frame comprises estimating motion of the video frame using at least one frame as a reference, generating a smoothed predicted frame by smoothing the predicted frame, and generating a residual frame by comparing the smoothed predicted frame with the video frame.

28. A recording medium having a computer readable program recorded therein, the program for executing a video decoding method, the method comprising:
reconstructing a low-resolution video frame from texture information obtained from a bitstream; and
reconstructing a video frame from the texture information using the reconstructed low-resolution video frame as a reference, and
wherein the step of reconstructing the video frame comprises inversely quantizing the texture information to obtain a spatially transformed frame, performing inverse spatial transform on the spatially transformed frame and obtaining a frame in which temporal redundancies are removed, generating a predicted frame for the frame in which the temporal redundancies have been removed, smoothing the predicted frame to generate a smoothed predicted frame, and reconstructing a video frame using the frame in which the temporal redundancies have been removed and the smoothed predicted frame.
